(19) United States
(12) Patent Application Publication
(10) Pub. No.: US 2019/0168582 A1
(43) Pub. Date: Jun. 6, 2019

(54) MULTI-TEMPERATURE TRANSPORTATION REFRIGERATION SYSTEM

(71) Applicant: Carrier Corporation, Palm Beach Gardens, FL (US)

(72) Inventors: Jian Sun, Palm Beach Gardens, FL (US); Xinliang Qiu, Palm Beach Gardens, FL (US); Jianhua Zhou, Palm Beach Gardens, FL (US)

(21) Appl. No.: 16/186,653

(22) Filed: Nov. 12, 2018

Related U.S. Application Data
(60) Provisional application No. 62/593,294, filed on Dec. 1, 2017.

(51) Int. Cl. B60H 1/32; F25B 5/02; F25B 39/04; F25D 11/02

(52) U.S. Cl. CPC B60H 1/3226; B60H 1/3232; B60H 1/323; F25B 2339/04; F25B 39/04; F25D 11/022; F25B 5/02

(57) ABSTRACT

A transportation refrigeration system includes an enclosure, and at least two compartments within the enclosure to be conditioned to two distinct temperatures. A refrigeration is circuit associated with each of the at least two compartments. A first refrigeration circuit includes a first compressor, a first evaporator, and a first expansion valve. A second refrigeration circuit includes a second compressor, a second evaporator, and a second expansion valve. The first and second refrigeration circuits utilize a common condenser, with first inlets into the condenser from the first circuit connected to a first flow passage and second inlets from the second circuit connected to second flow passages. First and second outlets are connected to the first and second flow passages. The first and second flow passages are staggered in a direction perpendicular to a flow passage across the condenser. A heat exchanger is also disclosed.

### CROSS-REFERENCE TO RELATED APPLICATION

This application claims priority to U.S. Provisional Application No. 62/593,294 filed on Dec. 1, 2017.

### BACKGROUND

This application relates to a multi-temperature transportation refrigeration system which cools two distinct environments to different temperatures and utilizes a common condenser.

Refrigeration systems are known. Generally, a compressor compresses a refrigerant and delivers it into a condenser. The refrigerant is cooled and passes through an expansion valve. The refrigerant is expanded and passes through an evaporator. The evaporator cools air to be delivered into an environment to be conditioned.

One application for such refrigeration systems is in a transportation refrigeration system. As an example, a truck may have a refrigerated trailer. It is known to provide distinct temperatures at distinct compartments within a common trailer. Individual refrigeration circuits are often utilized to provide the distinct temperatures.

### SUMMARY

In a featured embodiment, a transportation refrigeration system includes an enclosure, and at least two compartments within the enclosure to be conditioned to two distinct temperatures. The system has at least two refrigeration circuits, with a refrigeration circuit associated with each of the at least two compartments. A first of the at least two refrigeration circuits includes a first compressor, a first evaporator, and a first expansion valve. A second of the at least two refrigeration circuits includes a second compressor, a second evaporator, and a second expansion valve. The first and second refrigerant circuits utilize a common condenser, with first inlets into the condenser from the first circuit connected to a first flow passage and second inlets from the second circuit connected to second flow passages. First and second outlets are connected to the first and second flow passages, respectively. The first and second flow passages are staggered in a direction perpendicular to a flow passage across the condenser.

In another featured embodiment, a heat exchanger has first refrigeration circuit inlets leading to a plurality of first flow passages across a dimension of the heat exchanger, and second refrigeration circuit inlets leading to a plurality of second flow passages across the dimension of the heat exchanger, with the first and second flow passages being staggered across a direction parallel to the dimension.

These and other features may be best understood from the following drawings and specification.

### BRIEF DESCRIPTION OF THE DRAWINGS

FIG. 1 schematically shows a refrigeration transportation system.

FIG. 2A shows a first embodiment condenser that may be utilized in the FIG. 1 environment.

FIG. 2B shows a second embodiment condenser.

FIG. 2C shows a third embodiment condenser.

FIG. 2D shows a fourth embodiment condenser.

### DETAILED DESCRIPTION

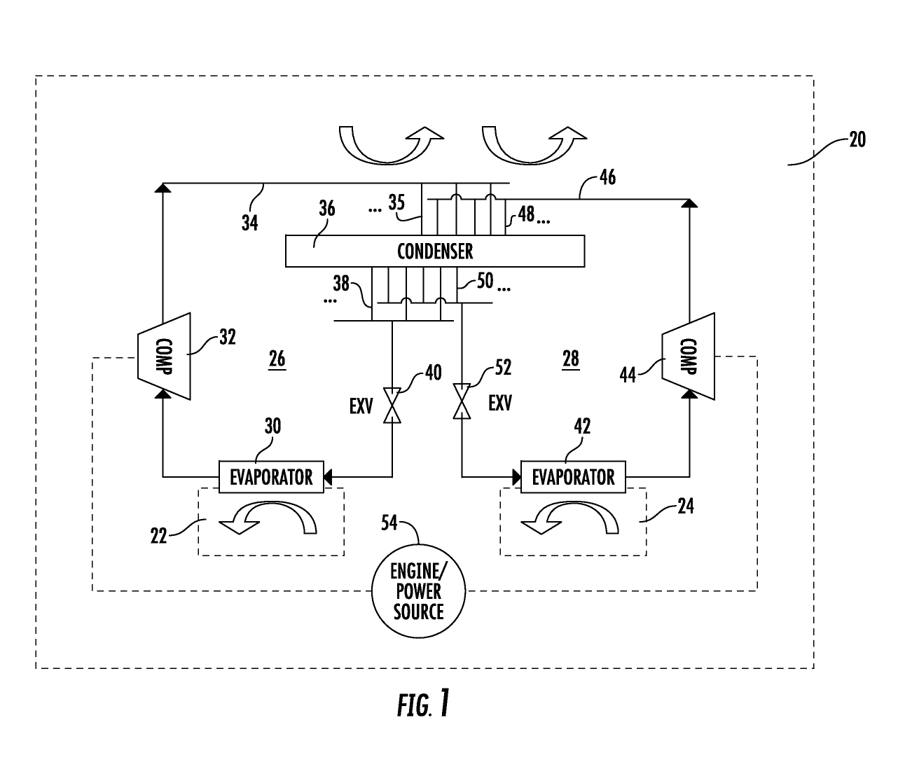

A refrigerated enclosure 20 is illustrated in FIG. 1. As known, the enclosure may be a refrigerated trailer associated with a truck. However, other applications for refrigerated enclosures may benefit from this disclosure. For purposes of this application, the term “enclosure” should extend to all enclosures, such as trailers, shipboard containers, etc.

Two distinct compartments 22 and 24 are illustrated. These two compartments are desirably cooled to distinct temperatures. As an example, one may be cooled to a lower temperature than the other. One may desirably maintain items stored within the compartment at a temperature below freezing, while the other may be at a higher, but still cooled, temperature.

The refrigeration circuit 26 is provided to maintain the compartment 22 at its temperature. A refrigeration circuit 28 is provided to maintain the compartment 24 at its temperature.

Refrigeration circuit 26 includes an evaporator 30. As known, a fan pulls air across the evaporator 30 to cool the air to the desired temperature for the compartment 22.

Downstream of the evaporator 30, the refrigerant passes to a first compressor 32 and then into a line 34 leading to inlets 35 into a condenser 36. Outlet lines 38 for the first circuit pass through an expansion valve 40 and back to the evaporator 30.

The circuit 28 includes an evaporator 42. Again, a fan will pull air across the evaporator 42 to cool it to the desired temperature for the compartment 24.

Downstream of the evaporator 42, the refrigerant passes to a second compressor 44 and then to a line 46 leading to inlet lines 48 into the condenser 36. Outlet lines 50 pass through an expansion valve 52 and back to the evaporator 42.

An engine or other power source 54 is shown to power both compressors 32 and 44.

As shown in this Figure, the inlet lines 35 and 48 are staggered. That is, they are interspersed in a direction perpendicular to a flow direction through the condenser 36. Notably, FIG. 1 is a schematic view and the flow direction may actually be across the larger dimension of the condenser 36 (in this Figure between the left and right).

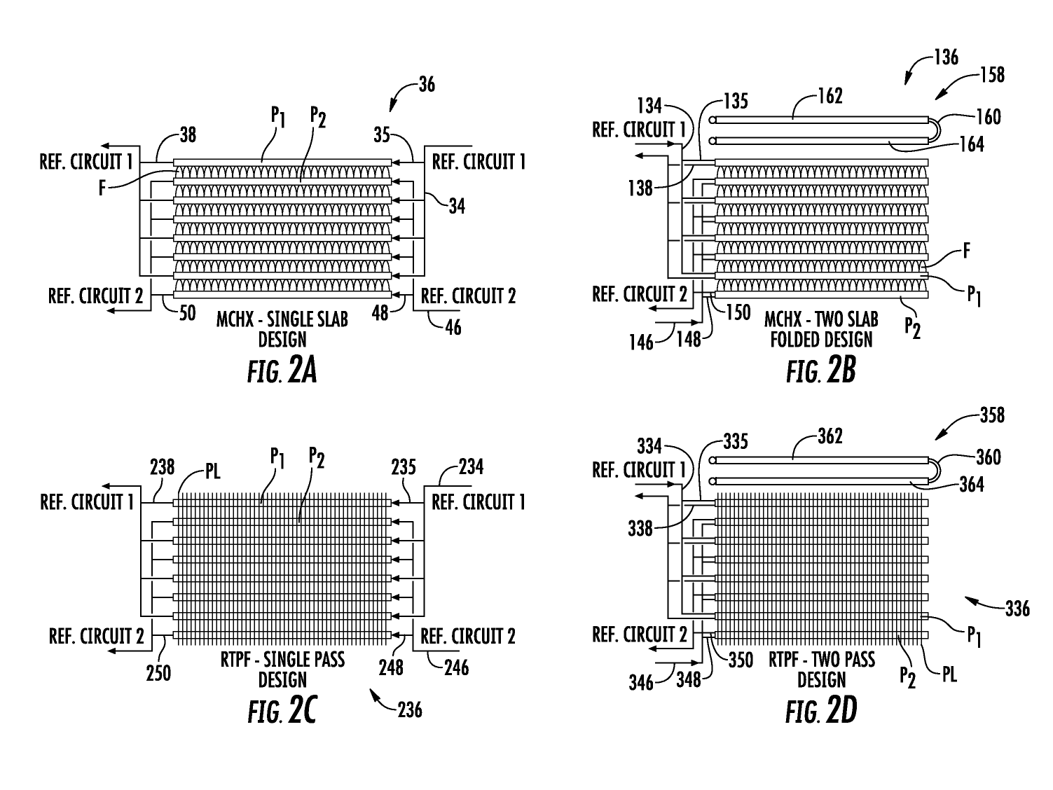

FIG. 2A shows a first embodiment 36 of the condenser. FIG. 2A may be a multi-louver flat-tube heat exchanger (alternatively referred to as “microchannel heat exchanger”). As known, microchannel heat exchangers have a plurality of channels spaced into the plane of this Figure and which provide very efficient heat transfer. The line 34 leads to a plurality of inlets 35 and passes to outlets 38 at an opposed end of the heat exchanger 36. Similarly, the line 46 leads to inlets 48 and outlets 50. As can be appreciated, the inlets 35 and 48 of the two circuits are staggered or interspersed in a direction perpendicular to a flow direction across the heat exchanger 36. The same is true of the outlets 38 and 50.

Multi-louver fins F assist in cooling the refrigerant in the heat exchanger, which are brazed to the flat tube.

FIG. 2B shows another embodiment 136, which is also a microchannel heat exchanger but with two-slab arrangement. The two circuits 134 and 146 enter into the heat exchanger on a first end and the outlets 138 and 150 are also at the first end. The actual structure of the channels across the heat exchanger may be as shown at 158. The first slab 162 passes across the dimension of the heat exchanger, reaches a turning elbow (which can be a folded unfinned flat tube) 160 and return back through the second slab 164 to the outlet. Although FIG. 2B only shows a 2-slab configuration, multi-slab (more than 3 slabs) configurations also belong to this scope of this invention.

FIG. 2C shows an embodiment 236. This embodiment may be a round tubes plate fin (P_{L}) heat exchanger. The inlet circuits 234 and 246 enter on one end to the circuits 235 and 248. The refrigerant passes across the heat exchanger to the outlets 238 and 250.

FIG. 2D shows another embodiment 336, which may be also a round tube plate fin heat exchanger. Here, the inlet circuits 334 and 346 enter at one end to inlets 335 and 348. The outlets 338 and 350 are at the same end.

Again, a tube structure 358 is utilized. The inlets pass into a tube 362 to a turning elbow 360, which may be a hairpin bend, and back to an outlet tube 364.

In each of the FIGS. 2A-D, first flow passages P₁ connect the first circuit inlets to first circuit outlets, and second flow passages P₂ connect the second circuit inlets to second circuit outlets.

While the embodiments in FIGS. 2A-2D are specifically disclosed as a condenser, a worker of ordinary skill in the art would recognize that other applications for the heat exchanger may benefit from this disclosure. As an example, the heat exchanger may be utilized in an evaporator, an economizer, etc. Generally, any refrigeration system having two refrigerant flows that desirably have cooling or heating may benefit from these several designs.

For purposes of this application, the term “staggered” can be taken to mean there is a first flow passage of a first circuit and a first flow passage of a second circuit spaced perpendicular to the first flow passage of the first circuit in a direction perpendicular to a flow direction across the heat exchanger. Further, there is a second flow passage of the first flow circuit spaced on an opposed side of the first flow passage of the second circuit from the first flow passage of the first circuit, and a second flow passage of the second circuit spaced on an opposed side of the second flow passage of the first circuit relative to the first flow passage of the second circuit.

The staggered arrangement provides valuable benefits to increase efficiency. As an example, should one of the two circuits 26 or 28 be stopped, the entire air side heat transfer surface area of the heat exchanger will still be utilized to cool the other circuit. In addition, it is known that the heat exchange capacity for a particular heat exchanger is dependent on the temperature of the refrigerant entering the heat exchanger. Thus, the heat exchanger will cool the refrigerant at a higher inlet temperature to a greater extent than the second refrigerant at the lower temperature and thus the automatic allocation of air-side heat transfer surface area is achieved

Although an embodiment of this invention has been disclosed, a worker of ordinary skill in this art would recognize that certain modifications would come within the scope of this disclosure. For that reason, the following claims should be studied to determine the true scope and content of this disclosure.

1. A transportation refrigeration system comprising:
an enclosure, and at least two compartments within said enclosure to be conditioned to two distinct temperatures;
at least two refrigeration circuits, with a refrigeration circuit associated with each of said at least two compartments, and a first of said at least two refrigeration circuits including a first compressor, a first evaporator, and a first expansion valve, and a second of said at least two refrigeration circuits including a second compressor, a second evaporator, and a second expansion valve; and
said first and second refrigeration circuits utilizing a common condenser, with first inlets into said condenser from said first circuit connected to a first flow passage and second inlets from said second circuit connected to second flow passages, and first and second outlets connected to said first and second flow passages, and said first and second flow passages staggered in a direction perpendicular to a flow passage across said condenser.

2. The transportation refrigeration system as set forth in claim 1, wherein said condenser is a microchannel heat exchanger.

3. The transportation refrigerant system as set forth in claim 2, wherein said microchannel heat exchanger has a dimension parallel to a flow path of refrigerant across said heat exchanger.

4. The transportation refrigeration system as set forth in claim 3, wherein said first and said second inlets entering at one side of said dimension, and said first and second outlets are at an opposed side of said dimension.

5. The transportation refrigeration system as set forth in claim 3, wherein said first and second inlets being at one end of said dimension, and said first and second outlets also being at said one end of said dimension, with said first and second flow passages passing across said dimension from said first and second inlets, respectively, to a folded region, and then extending back across said dimension to said first and second outlets.

6. The transportation refrigeration system as set forth in claim 1, wherein said heat exchanger is a round tube and plate fin heat exchanger.

7. The transportation refrigeration system as set forth in claim 6, wherein said round tube and plate heat exchanger has a dimension parallel to a flow path of refrigerant across said heat exchanger.

8. The transportation refrigeration system as set forth in claim 7, wherein said first and said second inlets entering at one side of said dimension, and said first and second outlets are at an opposed side of said dimension.

9. The transportation refrigeration system as set forth in claim 8, wherein said first and second inlets being at one end of said dimension, and said first and second outlets also being at said one end of said dimension, with said first and second flow passages passing across said dimension from said first and second inlets, respectively, to a bend and then extending back across said dimension to said outlets.

10. The transportation refrigeration system as set for in claim 1, wherein a first of said first flow passages and a first of said second flow passages spaced in a direction perpendicular to a flow direction across the heat exchanger, and a second of said first flow passages spaced on an opposed side of the first of the second flow passages from the first of the first flow passages, and a second of the second flow passages spaced on an opposed side of the second of the first flow passages relative to the first of the second flow passages.

11. A heat exchanger comprising:
first refrigeration circuit inlets leading to a plurality of first flow passages across a dimension of said heat exchanger, and second refrigeration circuit inlets leading to a plurality of second flow passages across said dimension of said heat exchanger, with said first and second flow passages being staggered across a direction parallel to said dimension.

12. The heat exchanger as set for in claim 11, wherein a first of said first flow passages and a first of said second flow passages spaced in a direction perpendicular to a flow direction across the heat exchanger, and a second of said first flow passages spaced on an opposed side of the first of the second flow passages from the first of the first flow passages, and a second of the second flow passages spaced on an opposed side of the second of the first flow passages relative to the first of the second flow passages.

13. The heat exchanger as set forth in claim 12, wherein said heat exchanger is utilized as a condenser.

14. The heat exchanger as set forth in claim 11, wherein said heat exchanger is a microchannel heat exchanger.

15. The heat exchanger as set forth in claim 14, wherein said first and said second inlets entering at one side of said dimension, and said first and second outlets are at an opposed side of said dimension.

16. The heat exchanger as set forth in claim 14, wherein said first and second inlets being at one end of said dimension, and said first and second outlets also being at said one end of said dimension, with said first and second flow passages passing across said dimension from said inlets to a folded region and then extending back across said dimension to said first and second outlets.

17. The heat exchanger as set forth in claim 11, wherein said heat exchanger is a round tube plate and fin heat exchanger.

18. The heat exchanger as set forth in claim 17, wherein said first and said second inlets entering at one side of said dimension, and said first and second outlets are at an opposed side of said dimension.

19. The heat exchanger as set forth in claim 17, wherein said first and second inlets being at one end of said dimension, and said first and second outlets also being at said one end of said dimension, with said first and second flow passages passing across said dimension from said inlets to a bend and then extending back across said dimension to said first and second outlets.

20. The heat exchanger as set forth in claim 11, wherein said heat exchanger is utilized as a condenser.
